(19) United States
(12) Patent Application Publication
(10) Pub. No.: US 2026/0330737 A1
(43) Pub. Date: Oct. 22, 2026

(54) DEVICE AND METHOD FOR GENERATING HUMAN MOTION ANIMATION

(71) Applicant: KOREA INSTITUTE OF SCIENCE AND TECHNOLOGY, Seoul (KR)

(72) Inventors: Adiya TSERENDORJ, Seoul (KR); Sang Hun KIM, Seoul (KR); Jung Eun LEE, Seoul (KR); Hwasup LIM, Seoul (KR)

(73) Assignee: KOREA INSTITUTE OF SCIENCE AND TECHNOLOGY, Seoul (KR)

(21) Appl. No.: 19/185,937

(22) Filed: Apr. 22, 2025

(51) Int. Cl. G06T 13/40; G06V 10/82

(52) U.S. Cl. CPC G06T 13/40; G06V 10/82

(57) ABSTRACT

In an animation generating device for human motions, as features of a first posture image and features of a second posture image are combined with an operation result of some layers among multiple layers of a first artificial neural network pair and features of a conditional image are combined with an operation result of some other layers among the multiple layers of the first artificial neural network pair, a posture represented by the first posture image and an appearance represented by the conditional image are reflected in a first output image, and at the same time, a posture represented by the second posture image and an appearance represented by the conditional image are reflected in a second output image.

### BACKGROUND

### 1. Field

The present disclosure relates to a device and method for generating human motion animation.

### 2. Description of the Related Art

Conventionally, generative adversarial networks (GANs) were used to generate animations representing human motions, or transformation methods using video-to-video were used. The conventional methods generate animations representing human motions by modeling a correlation of a fixed number of frames or by using previous frames to generate next frames based on a time-axis forward Markovian chain, but the conventional methods have problems in that length of the animations capable of being generated is limited and it is difficult to generate consistent and realistic images for a time axis.

The related art includes Korean Patent No. 10-2472299.

### SUMMARY

The present disclosure provides a device and method for generating an animation of a human motion that may generate consistent and realistic images for a time axis without any limitation on a length of the generated animation. The present disclosure is not limited to the technical object described above, and other technical objects may be derived from the following description.

Additional aspects will be set forth in part in the description which follows and, in part, will be apparent from the description, or may be learned by practice of the presented embodiments of the disclosure.

According to an aspect of the present disclosure, an animation generating device for human motions includes a main network configured to obtain a first output image corresponding to a first time point and a second output image corresponding to a second time point from a first artificial neural network pair by inputting a first noise image corresponding to the first time point and a second noise image corresponding to the second time point to each of the first artificial neural network pair including two identical artificial neural networks; a posture network configured to obtain features of a first posture image and features of a second posture image from a second artificial neural network pair by inputting a first posture image corresponding to the first time point and a second posture image corresponding to the second time point to each of the second artificial neural network pair including pairs corresponding to some layers of each artificial neural network of the first artificial neural network pair; and a conditional network configured to obtain features of a conditional image from a third artificial neural network by inputting the conditional image representing a human appearance condition to the third artificial neural network including multiple layers corresponding to the some layers of each artificial neural network of the first artificial neural network pair, wherein the first posture image represents a human posture at the first time point, and the second posture image represents a human posture at the second time point, as the features of the first posture image and the features of the second posture image are combined with an operation result of some layers among multiple layers of the first artificial neural network pair and the features of the conditional image are combined with an operation result of some other layers among the multiple layers of the first artificial neural network pair, the posture represented by the first posture image and an appearance represented by the conditional image are reflected in the first output image, and the posture represented by the second posture image and an appearance represented by the conditional image are reflected in the second output image, and a human motion animation is generated by repeatedly obtaining the first output image and the second output image of the main network while the first time point and the second time point are changed to correspond to a continuous generation of video frames.

The first artificial neural network pair may include two pair U-Net models that share weights.

The first noise image and the second noise image may be normal-distribution random noise images.

The features of the conditional image may be combined with the operation result of some other layers among the multiple layers of the first artificial neural network pair through an appearance block and a spatiotemporal block.

The main network may reduce noise of the first output image and noise of the second output image by repeatedly inputting the first output image and the second output image to the first artificial neural network pair respectively as the first noise image and the second noise image.

The main network may obtain a third output image corresponding to the first time point and a fourth output image corresponding to the second time point by inputting the first output image to the first artificial neural network pair as a fourth noise image corresponding to the second time point together with a third noise image corresponding to the first time point when the first output image and the second output image are input repeatedly K times respectively as the first noise image and the second noise image.

According to another aspect of the present disclosure, an animation generating method for human motions includes obtaining a first output image corresponding to a first time point and a second output image corresponding to a second time point from a first artificial neural network pair by inputting a first noise image corresponding to the first time point and a second noise image corresponding to the second time point to each of the first artificial neural network pair including two identical artificial neural networks; obtaining features of a first posture image and features of a second posture image from a second artificial neural network pair by inputting a first posture image corresponding to the first time point and a second posture image corresponding to the second time point to each of the second artificial neural network pair including pairs corresponding to some layers of each artificial neural network of the first artificial neural network pair; and obtain features of a conditional image from a third artificial neural network by inputting the conditional image representing a human appearance condition to the third artificial neural network including multiple layers corresponding to the some layers of each artificial neural network of the first artificial neural network pair, wherein the first posture image represents a human posture at the first time point, and the second posture image represents a human posture at the second time point, as the features of the first posture image and the features of the second posture image are combined with an operation result of some layers among multiple layers of the first artificial neural network pair and the features of the conditional image are combined with an operation result of some other layers among the multiple layers of the first artificial neural network pair, the posture represented by the first posture image and an appearance represented by the conditional image are reflected in the first output image, and at the same time, the posture represented by the second posture image and an appearance represented by the conditional image are reflected in the second output image, and a human motion animation is generated by repeatedly obtaining the first output image and the second output image while the first time point and the second time point are changed to correspond to a continuous generation of video frames.

The first artificial neural network pair may be trained by repeating operations of inputting a weighted sum image of a first learning image corresponding to the first time point and a first answer image corresponding to the first time point and a weighted sum image of a second learning image corresponding to a second time point and a second answer image corresponding to the second time point to the first artificial neural network pair; calculating a loss value between a first learning output image, which is obtained from the first artificial neural network pair, corresponding to the first time point and the first answer image and a loss value between a second learning output image, which is obtained from the first artificial neural network pair, corresponding to the second time point and the second answer image; calculating a sum of the loss value between the first learning output image corresponding to the first time point and the first answer images and the loss value between the second learning output image corresponding to the second time point and the second answer image; and updating a weight of the first artificial neural network pair based on the sum of the calculated loss values.

According to another aspect of the present disclosure, a computer-readable recording medium in which a program causing a computer to execute the animation generating is recorded.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an animation generating device according to an embodiment of the present disclosure;

FIG. 2 is a diagram illustrating a first artificial neural network pair according to an embodiment of the present disclosure;

FIG. 3 is a diagram illustrating a first artificial neural network pair, a second artificial neural network pair, and a third artificial neural network illustrated in FIG. 1;

FIG. 4 is a diagram illustrating a state in which a human motion animation is generated using an animation generating device according to the present embodiment;

FIG. 5 is a diagram illustrating a part of a first artificial neural network pair illustrated in FIG. 4;

FIG. 6 is a flowchart of a method of training an artificial neural network, according to an embodiment of the present disclosure; and

FIG. 7 is a diagram illustrating an operation of generating animation by using a recursive method using the animation generating device illustrated in FIG. 1.

### DETAILED DESCRIPTION

Hereinafter, embodiments of the present disclosure will be described in detail with reference to the drawings. Hereinafter, a device and method for generating a human motion animation capable of generating consistent and realistic images for a time axis without limitation on a length of an animation to be generated is described. Hereinafter, the device is briefly referred to as an “animation generating device” and the method is briefly referred to as an “animation generating method”.

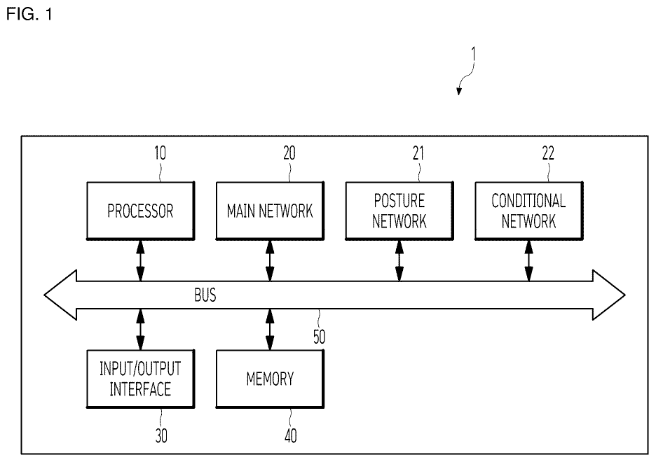

FIG. 1 is a configuration diagram of an animation generating device according to an embodiment of the present disclosure. Referring to FIG. 1, the animation generating device 1 according to the present embodiment includes a processor 10, a main network 20, a posture network 21, a conditional network 22, an input/output interface module 30, and a memory 40. The processor 10, the artificial neural network 20, the input/output interface module 30, and the memory 40 are connected to each other and may transmit data to each other. In order to easily understand the present embodiment while preventing features of the present embodiment from being obscured, essential configurations of the present embodiment are illustrated in FIG. 1. Those skilled in the technical field to which the present embodiments belong may understand that other configurations may be provided in addition to the configuration illustrated in FIG. 1.

The processor 10 may execute programs or commands stored in the memory 40. In this case, an operation program (for example, OS) for operating the animation generating device 1 may be stored in the memory 40. In addition, the processor 10 may execute a program for managing information on the animation generating device 1 and execute a program for managing an operation of the animation generating device 1 and the input/output interface module 30. A bus 50 serves to transmit data between the processor 10 and various components.

The main network 20 inputs a first noise image corresponding to a first time point t and a second noise image corresponding to a second time point t−1 to each of a first artificial neural network pair 201 consisting of two identical artificial neural networks, thereby obtaining a first output image corresponding to the first time point t and a second output image corresponding to the second time point t−1 from the first artificial neural network pair 201.

In the embodiment, the first artificial neural network pair 201 simultaneously generates images for both directions on time, that is, the first time point t and the second time point t−1, based on a diffusion model, thereby implementing an operation in which images are consistently and continuously connected over time without limiting a length of a video that may be generated. In the embodiment, the first time point t and the second time point t−1 are continuous time points, and the first output image corresponding to the first time point t and the second output image corresponding to the second time point t−1 form a continuous motion animation.

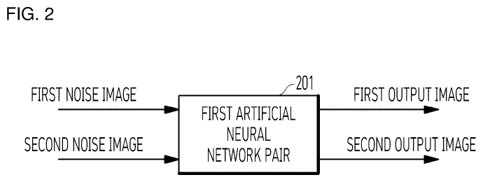

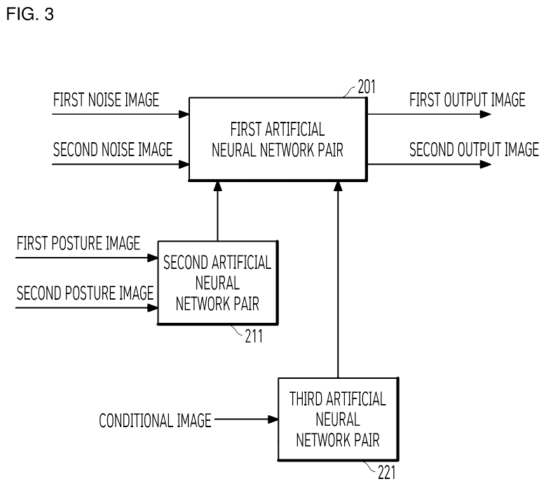

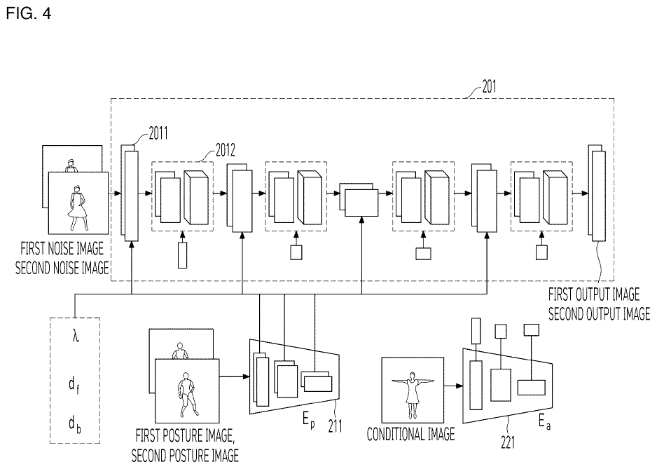

FIG. 2 is a diagram illustrating the first artificial neural network pair 201 according to the embodiment of the present disclosure, FIG. 3 is a diagram illustrating the first artificial neural network pair 201, a second artificial neural network pair 211, and a third artificial neural network 221 according to an embodiment of the present disclosure, and FIG. 4 is a diagram illustrating a state in which a human motion animation is generated using the animation generating device 1 according to the present embodiment.

As illustrated in FIG. 2, the first artificial neural network pair 201 according to the present embodiment receives a first noise image corresponding to the first time point t and a second noise image corresponding to the second time point t−1 as inputs and predicts a first output image corresponding to the first time point t and a second output image corresponding to the second time point t−1. In this case, the first noise image and the second noise image are normal-distribution random noise images.

The first artificial neural network pair 201 receives the first noise image corresponding to the first time point t and the second noise image corresponding to the second time point t−1 as inputs, and performs a convolution operation and a pooling operation multiple times on the input noise images to predict the first output image corresponding to the first time point t and the second output image corresponding to the second time point t−1. In the present embodiment, the first artificial neural network pair 201 is composed of two pair U-Net models that share weights.

Because the first artificial neural network pair 201 is composed of two pair U-Net models that share weights, the first noise image corresponding to the first time point t and the second noise image corresponding to the second time point t−1 are operated by the same weight, and the first output image corresponding to the first time point t and the second output image corresponding to the second time point t−1 predicted as an operation result are consistent with each other and guarantee continuity.

Also, in order to predict the first output image corresponding to the first time point t, a noise image and a posture image corresponding to the second time point t−1, which is a past time, are conditioned, and in order to generate the second output image corresponding to the second time point t−1, a noise image and a posture image corresponding to the first time point t, which is a future time, are conditioned. This means bidirectional learning on a time axis, and thus, images that are spatiotemporally consistent may be output.

In the present embodiment, the first noise image and the second noise image input to the first artificial neural network pair 201 are normal-distribution random noise images, and may be embedded and conditioned to be distinguished from each other.

Referring to FIG. 4, the first artificial neural network pair 201 includes a plurality of operation layers 2011 and a plurality of combination layers 2012. Each of the plurality of operation layers 2011 combines feature data input in pairs from a preceding layer with features of a posture image corresponding to the input feature data and output from a posture network 220, and performs a convolution operation to output paired feature data.

Each of the plurality of combination layers 2012 combines feature data input in pairs from the preceding layer with features of a conditional image corresponding to the input feature data and output from the conditional network 230, and performs a convolution operation to output paired feature data. As illustrated in FIG. 4, an operation result of each of the plurality of combination layers 2012 is used as an input of each of the subsequent operation layers 2011.

The posture network 21 inputs a first posture image corresponding to the first time point t and a second posture image corresponding to the second time point t−1 to each of the second artificial neural network pair 211 composed of a pair corresponding to some layers of each artificial neural network of the first artificial neural network pair 201, thereby obtaining features of the first posture image and features of the second posture image from the second artificial neural network pair 211.

The features of the first posture image and the features of the second posture image obtained from the second artificial neural network pair 211 are combined with operation results of some layers among multiple layers of the first artificial neural network pair 201.

The second artificial neural network pair 211 is composed of two pair networks that share weights. The second artificial neural network pair 211 receives the first posture image corresponding to the first noise image and the second posture image corresponding to the second noise image, encodes the input first and second posture images to be combined with operation results of some of the multiple layers of the first artificial neural network pair 201 and to have the same size as the operation results of some of the multiple layers of the first artificial neural network pair 201, and output the encoded images.

Because the second artificial neural network pair 211 is composed of two networks that share weights, the first posture image corresponding to the first time point t and the second posture image corresponding to the second time point t−1 are operated by the same weight, and accordingly, the first posture image and the second posture image may be temporally continuous and consistent.

The first posture image and the second posture image according to the present embodiment may be obtained in various ways that may express the pose information of a person in 2D. For example, each of the first posture image and the second posture image may be any one of the Densepose and Openpose results, and rendered body joint key points.

In addition, because the first artificial neural network pair 201 according to the present embodiment has left and right configuration which symmetrical, the number of features of the first and second posture images obtained from the second artificial neural network pair 211 may be less than the number of operation results of some layers of the first artificial neural network pair 201 that is a combination target. Referring to FIG. 4, it may be seen that one of three features obtained from the second artificial neural network pair 211 is combined with the operation results of the first artificial neural network pair 201 once during an encoding process and a decoding process.

The conditional network 22 inputs a conditional image representing a human appearance condition to the third artificial neural network 221 composed of multiple layers corresponding to some layers of each artificial neural network of the first artificial neural network pair 201, thereby obtaining features of a conditional image from the third artificial neural network 221.

The features of the conditional image obtained from the third artificial neural network 221 are combined with the operation results of some other layers among the multiple layers of the first artificial neural network pair 201, and due to this, the third artificial neural network 221 encodes the conditional image to have the same size as the operation results of some other layers among the multiple layers of the first artificial neural network pair 201.

In the present embodiment, the conditional image may be input as at least one of an image, a video, and random noise that may represent a human appearance.

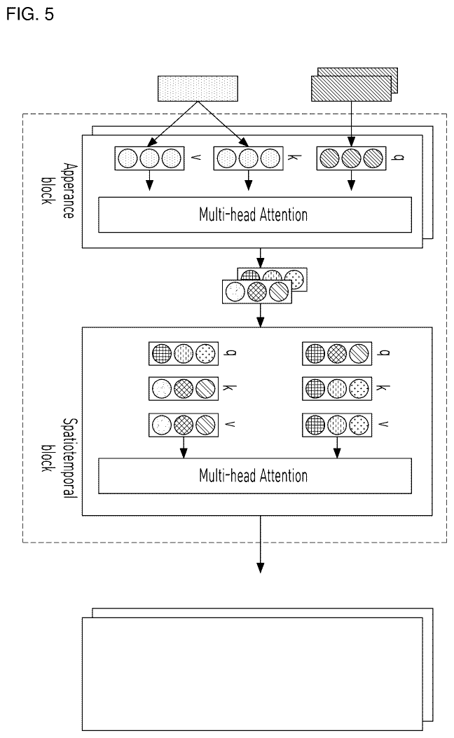

In an embodiment of the present disclosure, features of the conditional image obtained from the third artificial neural network 221 are combined with feature data output from the preceding operation layer 2011 of each combination layer 2012 of the first artificial neural network pair 201 through an appearance block and a spatiotemporal block. As illustrated in FIG. 5, the combination of the features of the conditional image obtained from the third artificial neural network 221 with the feature data output from the preceding operation layer 2011 is output as a pair of feature data, and the pair of output feature data is input to a subsequent operation layer 2011 and subjected to a convolution operation.

In addition, because the first artificial neural network pair 201 according to the present embodiment is configured symmetrically on the left and right, the number of features of the conditional image obtained from the third artificial neural network 221 may be less than the number of operation results of some layers of the first artificial neural network pair 201 that is a combination target. Referring to FIG. 4, it may be seen that one of the three features obtained from the third artificial neural network 221 is combined with the operation results of the first artificial neural network pair 201 once during an encoding process and a decoding process.

The animation generating device 1 according to the present embodiment combines features of the first posture image and features of the second posture image with the operation result of some layers among the multiple layers of the first artificial neural network pair 201 sharing weights, and combines features of the conditional image with the operation result of some other layers among the multiple layers of the first artificial neural network pair 201, and accordingly, a posture indicated by the first posture image and an appearance indicated by the conditional image are reflected in the first output image, and at the same time, a posture indicated by the second posture image and an appearance indicated by the conditional image are reflected in the second output image, and acquisition of the first output image and the second output image of the main network is repeated while the first time point t and the second time point t−1 are changed to correspond to the continuous generation of video frames to generate a human motion animation. Accordingly, a continuous and consistent human motion animation may be generated over time.

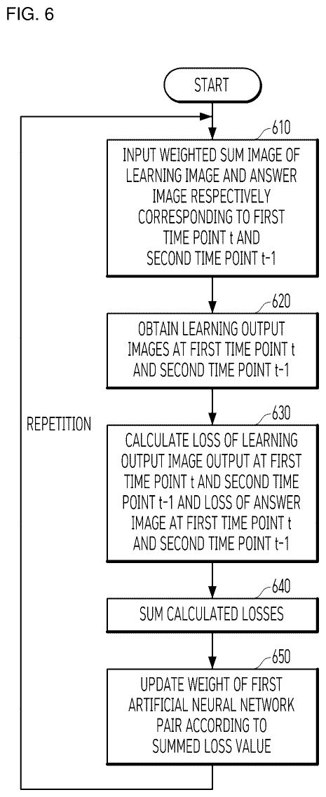

FIG. 6 is a flowchart illustrating a method of training the first artificial neural network pair 201, according to an embodiment of the present disclosure. Referring to FIG. 6, in operation 610, a weighted sum image of a first learning image corresponding to the first time point t and a first answer image corresponding to the first time point t and a weighted sum image of a second learning image corresponding to the second time point t−1 and a second answer image corresponding to the second time point t−1 are input to the first artificial neural network pair 201. In this case, the first answer image and the second answer image are two images randomly selected from a dataset. In the present embodiment, the dataset may be ground truth. Also, the first learning image and the second learning image may be normal-distribution random noise images.

In this case, a weight corresponding to a diffusion step k of the artificial neural network 20 is used for a weighted sum of a learning image and an answer image.

In operation 620, a first learning output image and a second learning output image corresponding to the first time point t and the second time point t−1 are obtained as a result which is obtained by operating the two weighted sum images input in operation 610 by the first artificial neural network pair 201. In this operation, two learning output images corresponding to the first time point t and the second time point t−1 are generated by the first artificial neural network pair 201, the second artificial neural network pair 211, and the third artificial neural network 221 described above, and redundant descriptions of respective configurations are omitted.

In operation 630, a loss value of the first learning output image corresponding to the first time point t output in operation 620 and the first answer image input in operation 610 is calculated, and a loss value of the second learning output image corresponding to the second time point t−1 output in operation 620 and the second answer image input in operation 610 is calculated.

More specifically, a difference between the first learning output image corresponding to the first time point t output in operation 620 and the first answer image input in operation 610 is calculated to calculate the loss value corresponding to the first time point t, and a difference between the second learning output image corresponding to the second time point t−1 output in operation 620 and the second answer image input in operation 610 is calculated to calculate the loss value corresponding to the second time point t−1.

In operation 640, the loss value corresponding to the first time point t output in operation 630 is added to the loss value corresponding to the second time point t−1.

In operation 650, the weight of the first artificial neural network pair 201 is updated based on the loss value added in operation 640. Returning to operation 610, operation 610 to operation 650 are repeated until the first artificial neural network pair 201 is sufficiently trained.

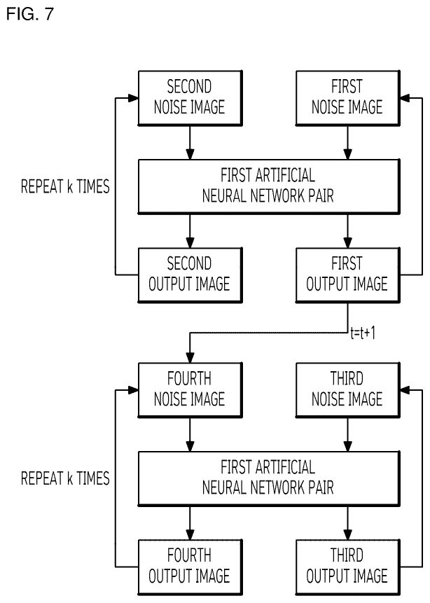

FIG. 7 is a diagram illustrating an operation of recursively generating an animation using the first artificial neural network pair 201 according to an embodiment of the present disclosure. First, the main network 20 inputs a first noise image corresponding to the first time point t and a second noise image corresponding to the second time point t−1 to the first artificial neural network pair 201 to obtain a first output image corresponding to the first time point t and a second output image corresponding to the second time point t−1. The first output image and the second output image are again input to the first artificial neural network pair 201 respectively as a first noise image corresponding to the first time point t and a second noise image corresponding to the second time point t−1. By repeating the operations K times, noise of the first output image and noise of the second output image may be reduced.

In this way, the first output image corresponding to the first time point t which is reduced in noise is input to the artificial neural network 20 as a fourth noise image corresponding to the second time point t−1 and a new random noise image is input to the artificial neural network 20 as a third noise image corresponding to the first time point t, and accordingly, the fourth output image corresponding to the second time point t−1 and the third output image corresponding to the first time point t may be obtained. The third output image and the fourth output image are input again to the first artificial neural network pair 201 respectively as the third noise image and the fourth noise image. By repeating the operations K times, noise of the third output image and noise of the fourth output image may be reduced.

The repetition is performed until all frames of the desired human motion animation are generated. For example, when a motion that a person sitting on a chair gets up is to be expressed, motions of a person standing up is repeated from an image (frame) showing a person sitting down to an image (frame) showing a person standing up.

In the animation generating device 1 according to the present embodiment, the first artificial neural network pair 201 is composed of two pair U-Net models that share weights, and accordingly, a first noise image corresponding to the first time point t and a second noise image corresponding to the second time point t−1 are operated by the same weight, and a first output image corresponding to the first time point t and a second output image corresponding to the second time point t−1 that are output as an operation result are consistent with each other and have guaranteed continuity.

In addition, because two noise images are input and two output images are obtained, a length of an animation may be increased by inputting as many noise images as desired, and thus, there is no limitation on the length of the animation.

A device and method for generating an animation representing human motions is provided in which features of a first posture image and features of a second posture image are combined with an operation result of some layers among multiple layers of a first artificial neural network pair, and features of a conditional image are combined with an operation result of some other layers among the multiple layers of the first artificial neural network pair, and accordingly, a human motion animation is generated in which a posture represented by the first posture image and an appearance represented by the conditional image are reflected in a first output image, and at the same time, a posture represented by the second posture image and an appearance represented by the conditional image are reflected in a second output image, and thereby, there are temporal continuity and consistency between output images. The present disclosure is not limited to the effects described above, and other effects may be derived from the above descriptions.

In addition, the animation generating device for human motions according to an embodiment of the present disclosure described above may be implemented by a program executable on a processor of a computer and may be implemented on a computer that records and executes the program on a computer-readable recording medium. The computer includes all types of computers that may execute programs, such as a desktop computer, a notebook computer, a smartphone, and an embedded-type computer. Also, a structure of the data used in one embodiment of the present disclosure described above may be recorded on a computer-readable recording medium through various means. The computer-readable recording medium includes a storage, such as random access memory (RAM), read only memory (ROM), a magnetic storage medium (for example, a floppy disk, a hard disk, or so on), or an optical reading medium (for example, compact disk (CD)-ROM, a digital video disk (DVD), or so on).

So far, the present disclosure is described by using preferred embodiments. Those skilled in the art to which the present disclosure pertains will be able to understand that the present disclosure may be implemented in a modified form without departing from the essential characteristics of the present disclosure. Therefore, the disclosed embodiments should be considered from an illustrative point of view rather than a limiting point of view. The scope of the present disclosure is described in the claims rather than the foregoing description, and all differences within the equivalent scope have to be construed as being included in the present disclosure.

What is claimed is:

1. An animation generating device for human motions, the animation generating device comprising:
a main network configured to obtain a first output image corresponding to a first time point and a second output image corresponding to a second time point from a first artificial neural network pair by inputting a first noise image corresponding to the first time point and a second noise image corresponding to the second time point to each of the first artificial neural network pair including two identical artificial neural networks;
a posture network configured to obtain features of a first posture image and features of a second posture image from a second artificial neural network pair by inputting a first posture image corresponding to the first time point and a second posture image corresponding to the second time point to each of the second artificial neural network pair including pairs corresponding to some layers of each artificial neural network of the first artificial neural network pair; and
a conditional network configured to obtain features of a conditional image from a third artificial neural network by inputting the conditional image representing a human appearance condition to the third artificial neural network including multiple layers corresponding to the some layers of each artificial neural network of the first artificial neural network pair,
wherein the first posture image represents a human posture at the first time point, and the second posture image represents a human posture at the second time point,
as the features of the first posture image and the features of the second posture image are combined with an operation result of some layers among multiple layers of the first artificial neural network pair and the features of the conditional image are combined with an operation result of some other layers among the multiple layers of the first artificial neural network pair, the posture represented by the first posture image and an appearance represented by the conditional image are reflected in the first output image, and the posture represented by the second posture image and an appearance represented by the conditional image are reflected in the second output image, and
a human motion animation is generated by repeatedly obtaining the first output image and the second output image of the main network while the first time point and the second time point are changed to correspond to a continuous generation of video frames.

2. The animation generating device of claim 1, wherein
the first artificial neural network pair includes two pair U-Net models that share weights.

3. The animation generating device of claim 2, wherein
the first noise image and the second noise image are normal-distribution random noise images.

4. The animation generating device of claim 3, wherein
the features of the conditional image are combined with the operation result of some other layers among the multiple layers of the first artificial neural network pair through an appearance block and a spatiotemporal block.

5. The animation generating device of claim 4, wherein
the main network reduces noise of the first output image and noise of the second output image by repeatedly inputting the first output image and the second output image to the first artificial neural network pair respectively as the first noise image and the second noise image.

6. The animation generating device of claim 5, wherein
the main network obtains a third output image corresponding to the first time point and a fourth output image corresponding to the second time point by inputting the first output image to the first artificial neural network pair as a fourth noise image corresponding to the second time point together with a third noise image corresponding to the first time point when the first output image and the second output image are input repeatedly K times respectively as the first noise image and the second noise image.

7. An animation generating method for human motions, the animation generating method comprising:
obtaining a first output image corresponding to a first time point and a second output image corresponding to a second time point from a first artificial neural network pair by inputting a first noise image corresponding to the first time point and a second noise image corresponding to the second time point to each of the first artificial neural network pair including two identical artificial neural networks;
obtaining features of a first posture image and features of a second posture image from a second artificial neural network pair by inputting a first posture image corresponding to the first time point and a second posture image corresponding to the second time point to each of the second artificial neural network pair including pairs corresponding to some layers of each artificial neural network of the first artificial neural network pair; and
obtain features of a conditional image from a third artificial neural network by inputting the conditional image representing a human appearance condition to the third artificial neural network including multiple layers corresponding to the some layers of each artificial neural network of the first artificial neural network pair,
wherein the first posture image represents a human posture at the first time point, and the second posture image represents a human posture at the second time point,
as the features of the first posture image and the features of the second posture image are combined with an operation result of some layers among multiple layers of the first artificial neural network pair and the features of the conditional image are combined with an operation result of some other layers among the multiple layers of the first artificial neural network pair, the posture represented by the first posture image and an appearance represented by the conditional image are reflected in the first output image, and at the same time, the posture represented by the second posture image and an appearance represented by the conditional image are reflected in the second output image, and
a human motion animation is generated by repeatedly obtaining the first output image and the second output image while the first time point and the second time point are changed to correspond to a continuous generation of video frames.

8. The animation generating method of claim 7, wherein the first artificial neural network pair is trained by repeating operations of
inputting a weighted sum image of a first learning image corresponding to the first time point and a first answer image corresponding to the first time point and a weighted sum image of a second learning image corresponding to a second time point and a second answer image corresponding to the second time point to the first artificial neural network pair;
calculating a loss value between a first learning output image, which is obtained from the first artificial neural network pair, corresponding to the first time point and the first answer image and a loss value between a second learning output image, which is obtained from the first artificial neural network pair, corresponding to the second time point and the second answer image;
calculating a sum of the loss value between the first learning output image corresponding to the first time point and the first answer images and the loss value between the second learning output image corresponding to the second time point and the second answer image; and
updating a weight of the first artificial neural network pair based on the sum of the calculated loss values.

9. A computer-readable recording medium in which a program causing a computer to execute the animation generating method of claim 7 is recorded.
